(19) United States
(12) Patent Application Publication
(10) Pub. No.: US 2007/0142105 A1
(43) Pub. Date: Jun. 21, 2007

(54) Auto extendable antenna and method of operation

(76) Inventors: Jose E. Korneluk, Lake Worth, FL (US); Craig G. Bishop, Boca Raton, FL (US); Timothy W. Heffield, Sunrise, FL (US); Rami C. Levy, Plantation, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/314,224

(22) Filed: Dec. 21, 2005

(51) Int. Cl. H04M 1/00

(52) U.S. Cl. 455/575.7

(57) ABSTRACT

An auto extendable antenna and method of operation at a wireless communication device (100) is disclosed. The method includes monitoring a set of reception parameters during a communication session. The processor (106) of the wireless communication device monitors the set of reception parameters for the communication session. The method further includes adjusting at least one physical dimension of the antenna (104) based on the set of reception parameters. An antenna system (108) of the wireless communication device adjusts at least one physical dimension of the antenna of the wireless communication device.

### FIELD OF THE INVENTION

The present invention generally relates to the field of wireless communication devices, and more specifically, to antennae in wireless communication devices.

### BACKGROUND OF THE INVENTION

Wireless communication devices use antennas for receiving signals during communication sessions. There are a number of factors that affect an antenna's performance during a communication session. Antenna length is one of the factors, which affect strength of the received signals for the communication session. For a continuous and error free communication session, a suitable antenna length is required. Hence, it becomes necessary to have a mechanism in place to maintain a suitable antenna length throughout the communication session.

Several methods are known in the art for extending the antenna for a communication session. In one known method for extending the antenna, a user of a wireless communication device extends the length of an external antenna manually whenever a communication session is to be initiated. Such methods for extending an antenna involve a high risk of damaging the antenna physically. Other methods known in the art for extending the antenna involve checking the signal strength at the initiation of the communication session. Such methods check the signal strength at the wireless communication device while the communication session is being initiated, and extends the antenna accordingly. However, these methods are not able to detect a change in the signal strength during the communication session. Hence, the quality of the communication session can suffer during the communication session, and can terminate the communication session in some cases. Further, the known methods in the art do not propose a change in the antenna length based on reception characteristics of a radio signal for the communication session. The reception characteristics of the radio signal may change during the communication session, and a different antenna length may be needed to maintain continuity in the communication session.

### BRIEF DESCRIPTION OF FIGURES

The present invention is illustrated by way of example and not limitation in the accompanying figures, in which like references indicate similar elements, and in which:

FIG. 1 illustrates a wireless communication device, in accordance with an embodiment of the present invention.

FIG. 2 represents a flowchart illustrating a method for adjusting at least one physical dimension of an antenna system of the wireless communication device based on a set of reception parameters, in accordance with an embodiment of the present invention.

FIGS. 3 and 4 represent a flowchart depicting a method for adjusting at least one physical dimension of the antenna system of the wireless communication device based on the set of reception parameters, in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail the particular auto extendable antenna and method of operation in accordance with the present invention, it should be observed that the present invention resides primarily in combinations of method steps and apparatus components related to the auto extendable antenna and method of operation. Accordingly, the apparatus components and method steps have been represented where appropriate by conventional symbols in the drawings, showing only those specific details that are pertinent to understanding the present invention so as not to obscure the disclosure with details that will be readily.

In this document, relational terms such as first and second, and the like may be used solely to distinguish one entity or action from another entity or action without necessarily requiring or implying any actual such relationship or order between such entities or actions. The terms ‘comprises’, ‘comprising’, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by ‘comprises . . . a’ does not, without more constraints, preclude the existence of additional identical elements in the process, method, article, or apparatus that comprises the element.

A ‘set’ as used in this document, means a non-empty set (i.e., comprising at least one member). The term ‘another’, as used herein, is defined as at least a second or more. The term ‘including’ as used herein, is defined as comprising.

Various embodiments of the present invention provide a method of operating an antenna in a wireless communication device. The method includes monitoring a set of reception parameters during a communication session. The method further includes adjusting at least one physical dimension of the antenna based on the set of reception parameters.

Various embodiments of the present invention further provide a wireless communication device. The wireless communication device includes a processor and an antenna system. The processor of the wireless communication device monitors a set of reception parameters during a communication session. Based on the set of reception parameters, the antenna system adjusts the at least one physical dimension of the antenna.

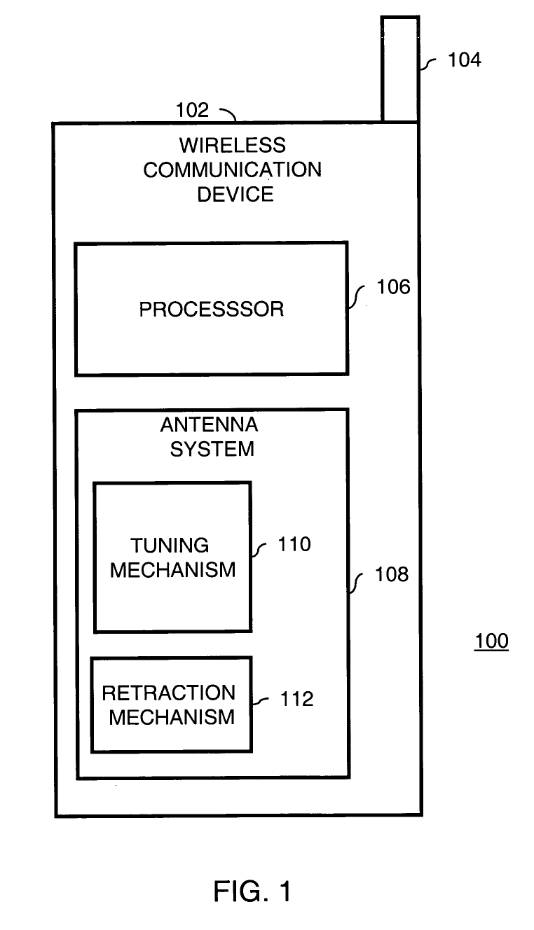

FIG. 1 illustrates a wireless communication device 100, in accordance with an embodiment of the present invention. The wireless communication device 100 can be used for the purpose of communication with other communication devices. Examples for the wireless communication device 100 include, but are not limited to, mobile phones, personal digital assistants (PDAs), wireless radio-sets, and so forth. The wireless communication device 100 interacts with other wireless communication devices by setting up communication sessions. A communication session is set up for transmission of information such as voice and data packets between the two wireless communication devices or between a wireless communication device and a source of information in a wireless communication network. Examples of sources of information in the wireless communication network include, but are not limited to, media gateways, media gateway controllers, base stations and radio access networks.

The wireless communication device 100 includes a body 102, an antenna 104, a processor 106, and an antenna system 108. The body 102 includes components of the wireless communication device 100, such as a housing, a battery, a keypad, and the like. The antenna 104 of the wireless communication device 100 receives radio signals for initiating a communication session. Once the communication session has been initiated, the antenna 104 continues to receive the radio signals during the communication session enabling continuous transmission of data or voice. The antenna 104 is extended to maintain a low-error and continuous communication session at the wireless communication device 100. The antenna 104 can be retracted at the end of the communication session.

The processor 106 of the wireless communication device 100 monitors a set of reception parameters for the communication session taking place at the wireless communication device 100. The reception parameters indicate how well the signal is being received. Exemplary reception parameters include, but are not limited to, a received signal strength indication (RSSI), a signal quality error (SQE), a bit error rate (BER), a vocoder faulting rate, a required signal-to-noise ratio (REQ), a time advance, reception characteristics of a radio signal, and a frequency band. The reception parameters for the communication session may vary due to many factors. For example, RSSI value of the radio signals may decrease to a value that is less than a threshold value when user of the wireless communication device enters a building. This may result in weak signal strength. In another example, when the user of the wireless communication device 100 is on the outskirts of a city where wireless communication network coverage is reduced, the value of SQE of the radio signals received at the wireless communication device 100 might increase to a value that is more than the upper threshold value of the SQE. The processor 106 audits the set of reception parameters when a communication session is initiated at the wireless communication device 100. In addition, the processor 106 monitors the set of reception parameters at the wireless communication device 100 during the communication session.

The antenna system 108 of the wireless communication device 100 is capable of adjusting at least one physical dimension of the antenna 104. For example, the antenna system 108 can vary a length of the antenna 104 by extending or retracting it. As another example, the antenna system 108 can vary an inclination of the antenna 104. As another example of adjusting the physical dimensions of the antenna 104, an impedance of matching component can be adjusted for optimal signal performance of the antenna 104. Further, the physical dimensions of the antenna 104 can also be adjusted by adjusting an effective surface area of the antenna 104 by rotation of an asymmetric antenna, by contracting or expanding the radius of a cylindrical antenna using electrical or mechanical means. In an embodiment of the present invention, the antenna system 108 includes a tuning mechanism 110 and a retraction mechanism 112. The tuning mechanism 110 can be used to tune the antenna 104 of the wireless communication device 100. The tuning mechanism 110 of the antenna system 108 may tune the antenna 104 at the initiation of the communication session and during the communication session. In another embodiment of the invention, the antenna system 108 may comprise at least one motorized mechanical assembly. The at least one motorized assembly can be used to adjust the length of the antenna or angle of deflection of the antenna. The retraction mechanism 112 is used to retract the antenna 104 at the end of the communication session. Further, the antenna 104 can be moved between fully extended or fully retracted positions in order to tune a radio of the antenna system 108 for a particular frequency component.

In an embodiment of the present invention, the wireless communication device 100 further includes an extension mechanism for extending the antenna 104. The extension mechanism and the retraction mechanism 112 of the antenna system 108 can be implemented using a spring and solenoid arrangement. The spring and solenoid arrangement can be used by the antenna system 108 for adjusting the at least one physical dimension of the antenna 104 based on the set of reception parameters at the wireless communication device 100. In another embodiment of the present invention, the spring of the antenna system 108 can be electrically coupled to a radiating element of the antenna 104. Hence, expansion or compression of the spring may change impedance characteristics of the antenna 104. In another embodiment of the present invention, the extension mechanism of the antenna system 108 can include a motor and a linear extension of the antenna. The motor and the linear extension of the antenna system 108 can change the electrical length of the antenna 104. In another embodiment of the present invention, the spring of the antenna system 108 may also be used as a tuning mechanism for tuning the antenna 104. It should be appreciated that the extension mechanism can further be designed using other design mechanisms.

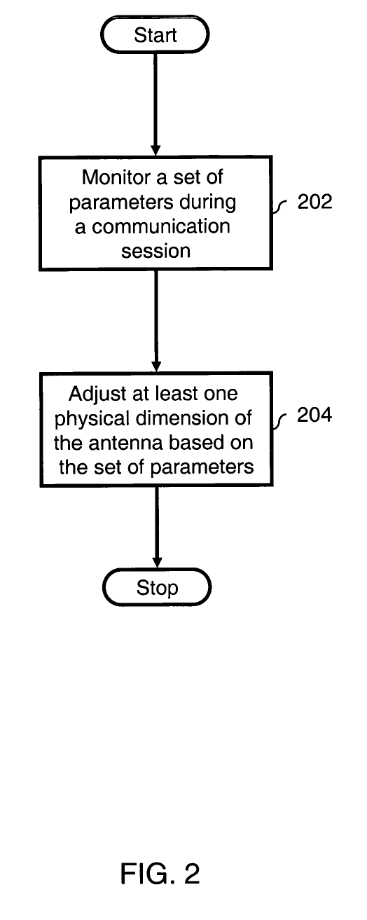

FIG. 2 represents a flowchart depicting a method for adjusting at least one physical dimension of the antenna of the wireless communication device based on the set of reception parameters, in accordance with an embodiment of the present invention. At step 202, the set of reception parameters is monitored during a communication session. The processor 106 of the wireless communication device 100 monitors the set of reception parameters. The set of reception parameters for the communication session at the wireless communication device 100 can include a received signal strength indication (RSSI), a signal quality error (SQE), a bit error rate (BER), a vocoder faulting rate, a required signal-to-noise ratio (REQ), a time advance, reception characteristics of the radio signal, and a frequency band. At step 204, at least one physical dimension of the antenna is adjusted based on the set of reception parameters. Examples of such physical dimensions include, but are not limited to, length of the antenna and inclination of the antenna. The antenna system 108 of the wireless communication device 100 adjusts at least one physical dimension of the antenna 104, when a threshold breach of any parameter is detected during the communication session. The set of reception parameters for the communication session may change due to many factors. For example, during a communication session at the wireless communication device 100, the RSSI value of the radio signal may decrease to a value that is less than the lower threshold of the RSSI value. The processor 106 of the wireless communication device 100 detects this change. Based on this change, the antenna system 108 extends the antenna 104 of the wireless communication device to a new length, which compensates for the reduction in the RSSI value at the antenna 104. The change in at least one physical dimension of the antenna 104 of the wireless communication device 100 can also avoid termination of the communication session due to lack of signal strength. For example, when a user of a wireless communication device 100 is on the outskirts of a city, the value of RSSI of the signal may decrease to a value that is less than a lower threshold value. The processor 106 detects this change in the value of RSSI. The antenna system 108 of the wireless communication device 100 increases the length of the antenna 104 of the wireless communication device 100 to compensate for this decrease in value of RSSI. In another example, when a user of the wireless communication device 100 enters a building or a constructed site during a communication session, SQE value of the radio signal may increase to a value that is more than the upper threshold of the SQE value. The processor 106 of the wireless communication device 100 detects change in the SQE value. Based on this change, the antenna system 108 increases the length of the antenna 104 to compensate for this increment in value of SQE. In yet another example, a change in frequency of the communication session at the wireless communication device 100 may require a change in antenna length. For example, the antenna length of 3.53 inches at a frequency of 836 MHZ may change to 3.21 inches at a frequency of 918 MHZ.

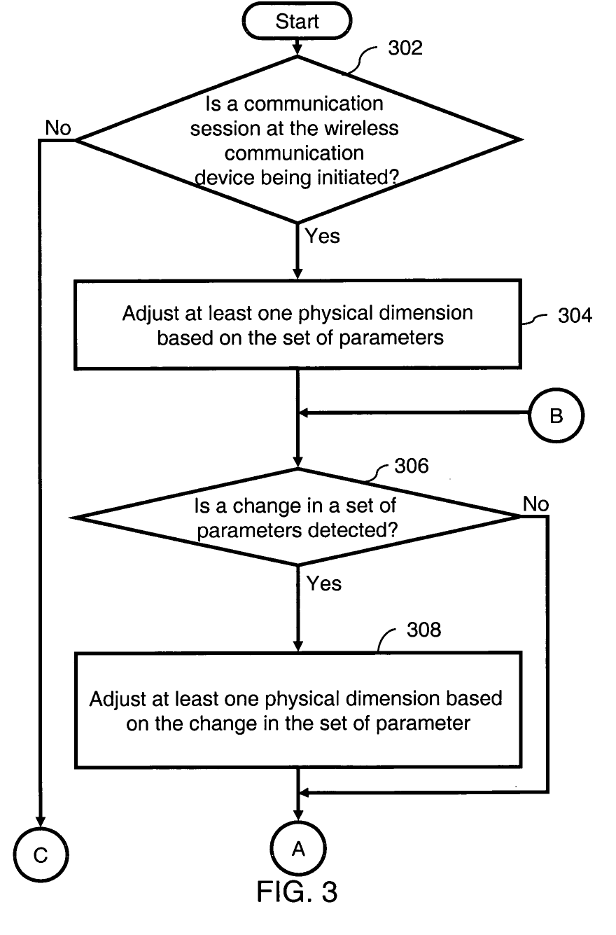

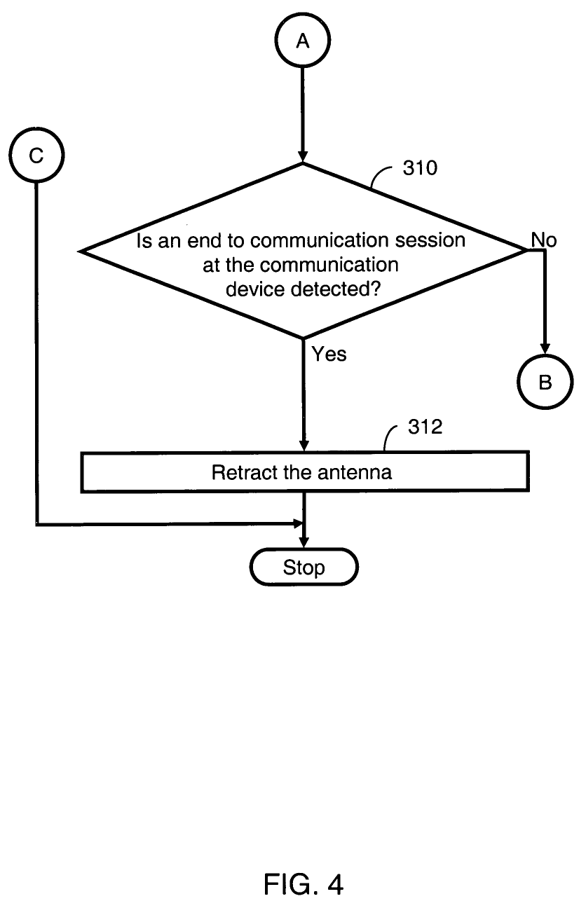

FIGS. 3 and 4 represent a flowchart depicting a method for adjusting at least one physical dimension of the antenna system of the wireless communication device 100 based on the set of reception parameters, in accordance with another embodiment of the present invention. At step 302, it is determined whether a communication session is initiated. The processor 106 of the wireless communication device 100 detects whether the communication session is initiated. When the communication session is not initiated, no change is made to the at least one physical dimension of the antenna 104. When the communication session is initiated, at step 304, the antenna system 108 adjusts at least one physical dimension of the antenna 104 based on the set of reception parameters received at the start of the communication session. At step 306, it is determined whether there is a change in any parameter in a set of reception parameters for the communication session. The processor 106 of the wireless communication device 100 determines whether there is a change in the set of reception parameters for the communication session. At step 308, at least one physical dimension of the antenna 104 is adjusted when a change in at least one of the set of reception parameters for the communication session, is detected. The antenna system 108 of the wireless communication device 100 changes at least one physical dimension of the antenna 104. At step 310, when no change in the set of reception parameters is detected, it is determined whether the communication session has ended. The processor 106 of the wireless communication device 100 checks for an end to the communication session at the wireless communication device 100. At step 312, when the end of the communication session is detected, the antenna 104 of the wireless communication device 100 is retracted. The antenna system 108 retracts the antenna 104 of the wireless communication device 100. When it is determined that the communication session has not ended, then the step 306 is performed again. The method is repeatedly performed until an end of the communication session is detected at the wireless communication device 100.

In an embodiment of the present invention, the set of reception parameters for the communication session can be configured based on a user defined preferences. The antenna system 108 of the wireless communication device 100 changes at least one physical dimension of the antenna 104 based on the set of reception parameters as defined by the user. Various embodiments of the present invention, as described above, enable automatic adjustment in a physical dimension of an antenna of the wireless communication device, and hence ensure a continuous communication session with reduced error at the wireless communication device. Moreover, since the antenna is automatically adjusted without any manual intervention from the user, there is a lower chance of antenna damage.

It will be appreciated that the auto extendable antenna and method of operation at a wireless communication device described herein may comprise one or more conventional processors and unique stored program instructions that control the one or more processors to implement, in conjunction with certain non-processor circuits, some, most, or all of the functions of the method for setting up the media session in a communication system described herein. The non-processor circuits may include, but are not limited to, a radio receiver, a radio transmitter, signal drivers, clock circuits, power source circuits, and user input devices. As such, these functions may be interpreted as steps of a method for auto extendable antenna at a wireless communication device. Alternatively, some or all functions could be implemented by a state machine that has no stored program instructions, or in one or more application specific integrated circuits ASICs, in which each function or some combinations of certain of the functions are implemented as custom logic. Of course, a combination of the two approaches could be used. Thus, methods and means for these functions have been described herein.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for operating an antenna in a wireless communication device, the method comprising:
monitoring a set of reception parameters during a communication session; and
adjusting at least one physical dimension of the antenna based on the set of reception parameters.

2. The method for operating an antenna in a wireless communication device as defined in claim 1, wherein adjusting the at least one physical dimension of the antenna comprises retracting the antenna on termination of the communication session.

3. The method for operating an antenna in a wireless communication device as defined in claim 1 further comprising configuring the set of reception parameters based on a predefined user preference.

4. The method for operating an antenna in a wireless communication device as defined in claim 1, wherein the set of reception parameters comprises at least one parameter selected from a group comprising a received signal strength indication (RSSI), a signal quality error (SQE), a bit error rate (BER), a vocoder faulting rate, a required signal-to-noise ratio (REQ), a time advance, a reception characteristics, and a frequency band.

5. A wireless communication device comprising:
a processor capable of monitoring a set of reception parameters during a communication session; and
an antenna system capable of adjusting at least one physical dimension of an antenna based on the set of reception parameters during the communication session.

6. The wireless communication device as defined in claim 5, wherein the antenna system further comprises a retraction mechanism for retracting an antenna on termination of the communication session.

7. The wireless communication device as defined in claim 5, wherein the set of reception parameters comprises at least one parameter selected from a group comprising a received signal strength indication (RSSI), a signal quality error (SQE), a bit error rate (BER), a vocoder faulting rate, an REQ, a time advance, a reception characteristic, and a frequency band.

8. The wireless communication device as defined in claim 5, wherein the antenna system comprises a tuning mechanism for tuning an antenna.

9. The wireless communication device as defined in claim 5, wherein the antenna system comprises at least one of a solenoid and a spring to adjust the antenna length.

10. The wireless communication device as defined in claim 5, wherein the antenna system comprises at least one of a motorized mechanical assembly to adjust the antenna length and or angle of deflection.
